(19) United States
(12) Patent Application Publication
(10) Pub. No.: US 2013/0071172 A1
(43) Pub. Date: Mar. 21, 2013

(54) COMPOSED ELEMENT

(71) Applicants: Luc Maertens, Lichtervelde (BE); Mark Cappelle, Staden (BE); Luc Vanhastel, Tielt (BE); Stefaan Blancke, Izegem (BE)

(72) Inventors: Luc Maertens, Lichtervelde (BE); Mark Cappelle, Staden (BE); Luc Vanhastel, Tielt (BE); Stefaan Blancke, Izegem (BE)

(73) Assignee: UNILIN, BVBA, Wielsbeke (BE)

(21) Appl. No.: 13/700,625

(22) PCT Filed: Mar. 25, 2011
(86) PCT No.: PCT/IB2011/051276

§ 371 Date: Nov. 28, 2012

(30) Foreign Application Priority Data
Jun. 3, 2010 (BE) BE2010/0341

(51) Int. Cl. F16B 5/00

(52) U.S. Cl. CPC F16B 5/0004
USPC 403/27; 403/382; 403/376

(57) ABSTRACT

Composed element comprising two or more panel-shaped elements, which each possess a coupling zone in which coupling parts are present in the form of a profiled part respectively extending in the longitudinal direction of the coupling zone concerned, wherein these profiled parts allow coupling the panel- shaped elements to each other in a locking manner and at angle, wherein the composed element comprises auxiliary means, which assist in a correct mutual assembly of the panel-shaped elements.

More particularly, the invention relates to a composed element comprising at least two panel-shaped elements, which are coupled to each other, can be coupled to each other, respectively. Herein, the invention relates to any form of composed element which comprises at least two or more panel-shaped elements, irrespective of the field of application, and irrespective of the fact whether the composed element substantially consists exclusively of the panel-shaped elements or these panel-shaped elements only form part thereof.

Although the invention can be utilized in any application, it is in particular intended for being applied in the sectors of furniture, walls and wall coverings. Herein, the invention relates in particular to connections between panel-shaped elements, and more particularly connections, which are intended for coupling panel-shaped elements to each other at an angle, for example, perpendicularly to each other.

More particularly, the invention relates to connections between panel-shaped elements, which can be realized in a smooth manner and are suitable for being applied in furniture which is sold in dismantled condition and must be assembled by the buyer himself. Herein, this relates in particular to so-called flat-pack furniture.

Still more particularly, the invention relates to a composed element comprising two or more panel-shaped elements, which each possess a coupling zone in which coupling parts are present in the form of a profiled part respectively extending in the longitudinal direction of the coupling zone concerned, preferably in the form of a tongue and a groove, respectively, wherein these profiled parts allow coupling the panel-shaped elements to each other in a locking manner and at angle. Such composed element is known, amongst others, from the document DE 20 2009 008 825 U1. The use of such profiled parts, which are provided in the panel-shaped elements themselves and are made entirely or largely in one piece therewith, offers the advantage that no separate elements are necessary for interconnecting the panels-shaped elements at an angle, such as, for example, metal connection elements, or that at least the use of such separate elements can be restricted to a minimum. Another advantage thereof consists in that profiled parts simply can be milled into the panel-shaped elements and that a continuous locking coupling can be realized along the entire corner connection.

The present invention aims at improving such composed element, in particular such as described in DE 20 2009 008 825 U1. The improvement is in particular intended for being employed, as aforementioned, in composed elements forming a piece of furniture, and more particularly composed elements, such as flat-pack furniture, which are intended for being assembled by the buyer. In particular with such furniture, there is the risk that the person assembling the furniture, during the assembly thereof, tries to couple a number of panel-shaped elements at the edges not belonging to each other, as a result of which there is a considerable risk that the profiled parts will become damaged and finally the furniture can not be assembled correctly any more. According to a first aspect, the invention aims at excluding this disadvantage or at least reducing the aforementioned risk.

To this aim, the invention, according to a first aspect, thus also relates to a composed element comprising two or more panel-shaped elements, which each possess a coupling zone in which coupling parts are present in the form of a profiled part respectively extending in the longitudinal direction of the coupling zone concerned, wherein these profiled parts allow coupling the panel-shaped elements to each other in a locking manner and at angle, with the characteristic that the composed element comprises auxiliary means, which assist in a correct mutual assembly of the panel-shaped elements. By using such auxiliary means, the advantage is obtained that the person assembling the piece of furniture or possibly another composed element, at least for a certain number of the corner connections of the composed element is made aware thereof and automatically is led into the right direction in order to bring the respective component parts together in a correct manner.

It is noted that by a “coupling zone”, the portion of a panel-shaped element is to be understood in which the aforementioned profiled part, for example, profiled groove part or profiled tongue part, is extending. Herein, this may relate to an edge zone, thus, a zone situated at an edge of the panel-shaped element or in the immediate proximity of said edge, as well as a zone which is clearly distant from the edge of a panel-shaped element, for example, when this zone is intended for forming a T-coupling between panel-shaped elements.

According to a first possibility, the aforementioned auxiliary means are configured such that they prevent coupling the wrong panel-shaped elements to each other and/or coupling panel-shaped elements to each other with the incorrect coupling zones. According to another, second possibility, they can also be configured such that they prevent coupling the panel-shaped elements to each other in a mutually shifted position. By “preventing”, as explained in the following, it can be intended that an effective mechanic prevention is existing, which prevents coupling certain parts to each other in an incorrect manner, as well as there are solely indications, which, when being followed correctly by the user, result in that a wrong manner of coupling is excluded.

According to a preferred embodiment, the aforementioned auxiliary means substantially consist of indications provided at least on a number of the panel-shaped elements. As the person assembling the composed element then automatically will see these indications, then, at least when said person follows these indications, it is prevented that composing parts not matching each other will be tried to be interconnected.

Preferably, said indications consist of corresponding indications, which respectively are provided on the respective two panel-shaped elements to be connected.

According to a particularly preferred embodiment, the indications are formed at least by marks provided on the surface. More particularly, it is preferred that these marks consist of color marks, wherein matching parts, in other words, the parts where two panel-shaped elements have to be coupled to each other, are marked with the same color. More specifically, it is preferred that at least two colors are applied, wherein preferably unique color codes are used. For example, the matching parts of a first corner connection both can be marked with a first color, whereas the two matching parts of another corner connection are marked with another, second color.

Preferably, the aforementioned color indications are realized as a coloring agent, for example, a paint product, ink product or the like, which is applied on the surface. According to a variant, the color mark is realized at least at one of the two cooperating coupling zones in the form of a separate material part with a differing color. By this latter, it is intended, for example, that a colored synthetic material strip is provided on a respective coupling zone, more particularly at a profiled part, in order to form a color mark in this manner, wherein such separate material part, for example, such synthetic material strip, possibly may also have another function.

According to a particular embodiment, the separate material part forms a functional part of the coupling parts.

In a particular embodiment, the composed element is characterized in that the coupling parts comprise a tongue and a groove, which are provided with locking parts; that the tongue is provided with a slit extending substantially in the direction of the tongue; and that the aforementioned material part consists of a strip-shaped support element provided in the slit, more particularly a synthetic material strip, which forms an elastic support and/or connection between the two portions of the split tongue.

The marks also may consist of indices, whether or not combined with the use of colors, such as, for example, red stripes, blue triangles, letter indices, and so on.

According to a variant, the aforementioned indications comprise three-dimensional form elements, such as at least one protrusion and a recess cooperating therewith, wherein then it is obvious to the person assembling the composed element that the component parts, more particularly the panel-shaped elements, have to be presented to each other in such a manner that the protrusion is positioned in front of the recess. It is clear that these three-dimensional form elements then preferably are provided such that interconnecting is only possible in well-defined unique positions. Of course, the use of such three-dimensional form elements can be combined with the use of marks in the form of colors, inscriptions or the like. In the most preferred embodiment, indeed such combination will be applied, wherein then, for example, a first protrusion with a pertaining recess is marked in a first color, whereas another protrusion and a pertaining recess then are marked in another color.

According to a particular embodiment of the invention, the aforementioned auxiliary means are realized as obstruction elements, which mechanically prevent a certain incorrect mutual assembly of the panel-shaped elements.

Preferably, the aforementioned three-dimensional form elements, obstruction elements, respectively, comprise one or more corresponding protrusions and recesses, which, at least in the case when they are intended as obstruction means, fit into each other when correctly assembled, however, counteract the fitting together in the event of one or more forms of an incorrect assembly occurring.

It is noted that the use of three-dimensional form elements and/or obstruction elements also offers the advantage that persons experiencing difficulties with the perception of colors, such as color-blind persons, still are offered assistance in the assembly, such contrary to applications wherein color marks are used exclusively.

In a particular preferred embodiment, the composed element is characterized in that the aforementioned coupling parts comprise a tongue and a groove and that at least one protrusion is situated in the groove, whereas the recess is provided in the tongue, preferably in the form of a local interruption in the tongue profile. It is clear that herein, the protrusion and the recess preferably are situated at such a location that they can only cooperate when the correct panel-shaped elements are presented to each other with the correct coupling parts. By integrating them into the profiled parts of tongue and groove, the auxiliary means can be provided at the panel-shaped elements in a practical manner.

In a practical embodiment, the one or more protrusions are formed by one or more plugs protruding from the bottom of the groove. The corresponding recesses then may consist of openings formed in the tongue, and more particularly local interruptions formed in such tongue.

It is noted that in other embodiments than where the protrusions are situated in the groove, for such protrusions use can be made of plugs provided in openings. The use of plugs is in fact very practical for realizing such protrusions. The corresponding recesses thus possibly can be made as simple bore holes.

In a particular embodiment, one or more of the protrusions shall be situated next or substantially next to the tongue and groove. The protrusion then preferably is situated at the panel-shaped element comprising the tongue, whereas the recess is formed in the panel-shaped element comprising the groove. In that case, too, for the protrusions preferably use is made of plugs, which then in the assembled condition of the composed element cooperate, for example, with recesses in the form of bore holes.

All aforementioned auxiliary means preferably are provided such on the panel-shaped elements that they are hidden from view in the coupled condition of the panel-shaped elements.

The invention shows its advantages in particular with composed elements comprising coupling zones with coupling parts which are made in the form of a tongue and a groove, wherein these coupling parts also comprise locking parts and wherein the tongue is made asymmetrical and preferably comprises a locking element on one side only. It is in particular with such coupling parts that an incorrect manipulation during assembly can result very quickly in damage to these coupling parts.

Also in particular with composed elements in which the profiled tongue part is realized as a split tongue, the use of such auxiliary means is strongly advised, as in such case, too, an incorrect assembly, or an attempt of incorrect assembly, may result very quickly in damage, such as a fracture in a portion of the tongue, as a result of which an appropriate final coupling is no longer possible.

Still in particular, the invention shows its advantages when the coupling parts, and more particularly the aforementioned coupling parts, are applied with panel-shaped elements substantially consisting of particle board, MDF board or HDF board, wherein the aforementioned profiled parts then are realized from this material. Indeed, it is known that such materials relatively fast tend to crumble away and/or to split off when undesired forces are exerted on them, which thus forms another reason to provide for that the component parts of such composed element are interconnected in the correct manner already from the first time.

Further, it is noted that the aforementioned auxiliary means, irrespective whether this relates to marks in the form of color indications, inscriptions or indices, or three-dimensional form elements, preferably are provided asymmetrically in respect to the longitudinal direction of the coupling zones. By this, it is intended that these auxiliary means are not provided precisely in the middle of two panel-shaped elements to be coupled, but rather at the left or right hand side from the center, as a consequence of which only one mutual pertaining positioning is possible.

Further, it is also preferred that the aforementioned auxiliary means are such that they are situated within the large flat sides of the panel-shaped elements, such that the panel-shaped elements at their flat sides are free from protrusions extending beyond these flat sides. It is clear that this is of particular importance with flat-pack furniture, as such protruding parts would render packaging difficult.

According to a second independent aspect, the invention relates to a composed element comprising at least two panel-shaped elements, which possess a coupling zone in which coupling parts are present in the form of a respective profiled part, wherein these profiled parts allow coupling the panel-shaped elements to each other in a locking manner and at angle by putting down one of the panel-shaped elements and coupling the other panel-shaped element to the put-down panel-shaped element by means of an upward turning movement, with the characteristic that the composed element comprises auxiliary means, which assist the upwardly turned panel-shaped element in remaining upright during the further assembly of the composed element. Indeed, when installing such composed element, there is a risk that, when one panel-shaped element is turned in a put-down panel-shaped element by means of an upward turning movement, the first panel-shaped element will tilt back by itself while one wants to mount other panel-shaped elements to the whole, which creates the risk of causing damages or the risk that the person assembling the piece of furniture will be injured. By the use of such auxiliary means, this is excluded or the risk of serious consequences is minimized.

According to a first possibility, these auxiliary means comprise an auxiliary element provided in at least one of the panel-shaped elements which are to be interconnected. The advantage thereof is that such auxiliary element can be delivered as a component part of the furniture and/or can be provided automatically.

According to a second possibility, the auxiliary means comprise an auxiliary element in the form of a separate tool, more particularly a tool developed in particular for this purpose. Such tool offers the advantage that thereby a solid support can be offered to the panel-shaped element so it would not topple over, and that the panel-shaped elements as such will have to be adapted only to a minor extent or not at all.

Such separate tool can be performed, for example, in the form of an element which engages in small faces of the coupled panel-shaped elements and in this manner locks them in mutual respect, or in the form of an element which can be placed temporarily against the inner corner of coupled-together panel-shaped elements, or in the form of an element which is inserted into the split tongue. Practical embodiments thereof will be described below with reference to the drawings.

It is clear that the invention also relates to a method for assembling such composed element, with the characteristic that herein use is made of auxiliary means, such as aforementioned and also as described below, in order to realize an at least temporary locking against the toppling over of a panel-shaped element.

According to a third independent aspect, the invention relates to a composed element comprising at least two panel-shaped elements, which each possess a coupling zone in which coupling parts are present in the form of a respective profiled part, wherein these profiled parts allow coupling the panel-shaped elements together in a locking manner and at an angle; wherein these profiled parts are made in the form of a tongue and a groove; wherein the groove is sealed towards at least one extremity by means of a sealing element forming a support and/or protection for a finishing strip provided on a small edge, more particularly small face, perpendicularly to the direction of the groove, with the characteristic that the sealing element consists of a plug provided in a bore hole, wherein this bore hole and the plug extend with their longitudinal axis substantially parallel to the profiled part concerned. The use of a sealing element is already known from document DE 20 2009 008 825 U1, wherein the sealing element consists of a material block which is placed in a milled-out recess. Realizing such milled-out recess, however, requires a complicated operation. By using, according to the invention, a bore and a plug provided therein, a considerably simpler production process is achieved. The fact that the profiled part of the groove possibly is not sealed by the plug over the entire diameter as said plug is circular, does not pose any problem. In this case, the finishing strip will not be completely protected and/or supported, however, as the major part of the finishing strip at the location of the profiled part of the groove in fact is supported and/or protected by the plug, sufficient protection can be offered to the finishing strip, whereas a simple production remains possible.

It is clear that the invention also relates to a method for realizing this, said method being characterized in that a hole is bored at the extremity of the groove and a sealing element in the form of a plug is provided in said hole.

According to a fourth aspect, the invention relates to a composed element comprising at least two panel-shaped elements, which each possess a coupling zone in which coupling parts are present in the form of a respective profiled part, wherein these profiled parts allow to couple the panel-shaped elements to each other in a locking manner and at an angle; wherein these profiled parts are made in the form of a tongue and a groove; wherein the groove is sealed towards at least one extremity by means of a sealing element forming a support and/or protection for a finishing strip provided on a small edge perpendicularly to the direction of the groove, with the characteristic that the sealing element comprises a locking part, which, in the coupled condition of the aforementioned panel-shaped elements, cooperates with the panel-shaped element comprising the tongue. In this manner, an additional function is given to the sealing element, which contributes to an improvement of the composed element. By the cooperation, it is meant that by means of the sealing element, a locking or coupling between the panel-shaped elements is realized. The locking may be a main locking for keeping the panel-shaped elements together, whether or not in combination with other locking manners, however, it may as well be an additional locking, for example, in order to keep an upright standing panel-shaped element temporarily upright during assembly.

According to a fifth independent aspect, the invention relates to a composed element comprising at least two panel-shaped elements, which each possess a coupling zone in which coupling parts are present in the form of a respective profiled part, wherein these profiled parts allow to couple the panel-shaped elements to each other in a locking manner and at an angle; wherein these profiled parts are made in the form of a tongue and a groove; wherein the tongue is made as a split tongue, which, by means of a slit, is divided into at least two parts; wherein this split tongue comprises a locking part at least at one side, which locking part can cooperate with a locking part in the groove; wherein in said slit, a support element is provided which extends between the directed towards each other sidewalls of the slit; with the characteristic that the support element consists of a cord-like element, which is provided in the slit in the form of an element which has already been given the form of a cord beforehand. The use of a support element which is provided in the slit of a tongue profile is known from document DE 20 2009 008 825 U1. According to this known form, an elastic synthetic material is provided in the slit, for example, injected therein. Herein, there is a risk that the support element does not have a uniform cross-section, that local accumulations of synthetic material may occur and that the panel-shaped elements can be soiled with the synthetic material. However, by now making use of a support element already having the form of a cord beforehand, thus, preferably having a well-defined uniform cross-section, the advantage is obtained that the risk of these disadvantages is excluded.

According to a sixth independent aspect, the invention relates to a composed element in the form of a piece of furniture, which comprises a plurality of panel-shaped elements and a back part provided between said panel-shaped elements, which back part is seated in grooves provided in the panel-shaped elements, with the characteristic that in one or more of the aforementioned grooves an industrially dimensioned tensioning and/or filling means is present, which, in the final assembled condition of the composed element, enhances the stability which is provided to the composed element by the back part. Alternatively, such tensioning and/or filling means can also be applied on one or more edges of the back part. Herein, this relates to elements and a back part which have to be assembled by the user, wherein the tensioning and/or filling means thus already has been industrially dimensioned beforehand. Possibly, said tensioning and/or filling means can already be provided industrially in said groove and/or at the respective edge of the back part. According to a variant, the tensioning and/or filling means is delivered in industrially dimensioned form together with the element to be composed. This latter may be, for example, in the form of an elastically compressible cord of a well-defined thickness, which must be provided in said groove by the assembling person prior to providing the back part therein.

The sixth independent aspect is particularly useful with a composed element, such as furniture, which is composed of at least a number of panel-shaped elements and a back part fitting in grooves provided for this purpose, wherein at least a number of the panel-shaped elements can be locked together by means of profiled parts at the edges and the presence of the back part contributes to the dimensional stability of the whole. Such composed elements, the panel-shaped elements of which are coupled to each other by means of profiled parts, in particular by means of turning and/or snap couplings, often show the characteristic to be somewhat movable, wherein the dimensional stability thus must be achieved via the back part. With the slightest play of the back part in the grooves, viewed in the direction of the plane of the back part, a not very stable construction will be obtained. By applying a tensioning and/or filling means which is industrially and consequently preferably also uniformly dimensioned, this disadvantageous effect can be reduced.

The tensioning and/or filling means can be an elastically or plastically compressible element, for example, in the form of a cord; however, it may also be an element, matter or strip consisting of a deformable substance, which is activated shortly before, during or after the application of the back, for example, is solidified, after which this element then provides for an immobile filling between the back part and the walls of the groove.

It is noted that all aforementioned aspects can be combined at choice inasmuch as they do not show any contradictory characteristics; such according to all combinations which are possible between these aspects.

Further characteristics of the invention will become clear from the description following below and from the appended claims.

With the intention of better showing the characteristics, hereafter, as an example without any limitative character, some preferred embodiments are described, with reference to the accompanying drawings, wherein:

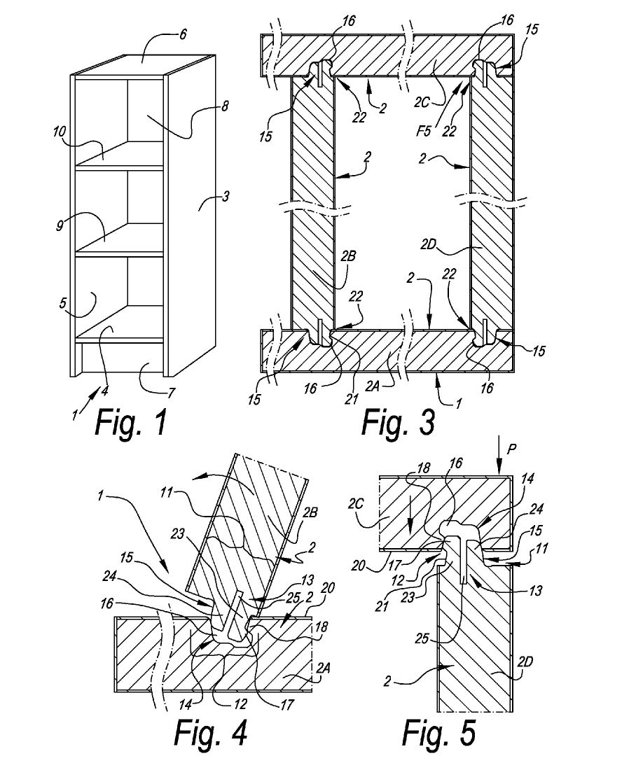

FIG. 1 in perspective represents a composed element according to the invention, in the form of a piece of furniture;

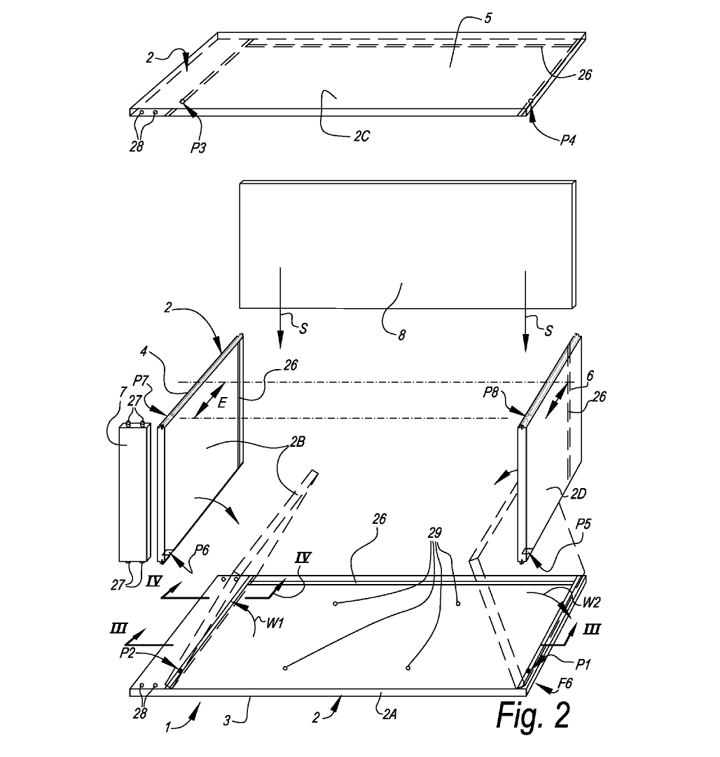

FIG. 2 represents the composed element of FIG. 1 during assembly;

FIG. 3 represents a cross-section according to line III-III in FIG. 2 in the assembled condition;

FIG. 4 represents a cross-section according to line IV-IV in FIG. 2, thus, during assembly;

FIG. 5 represents the portion indicated by F5 in FIG. 3, also during the assembly thereof;

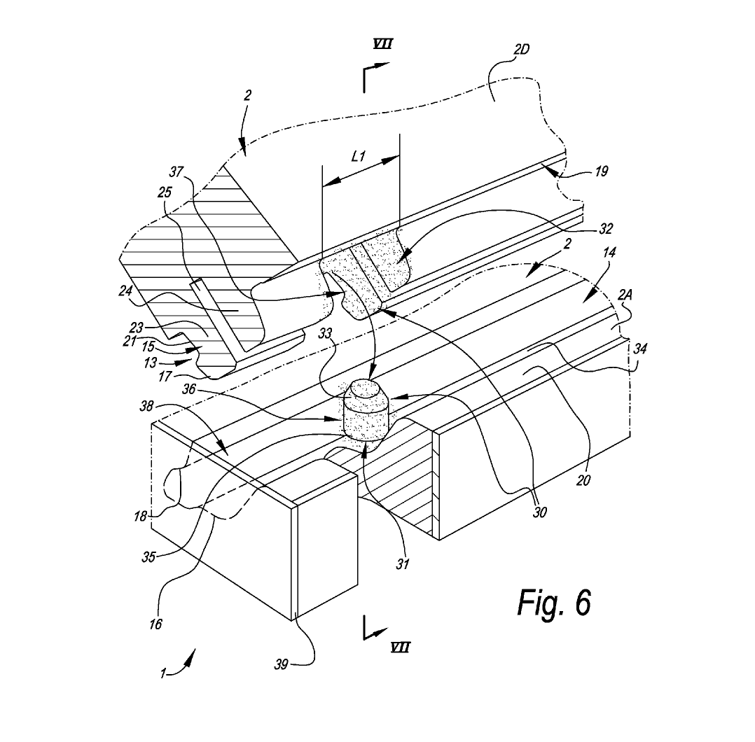

FIG. 6, at a larger scale, represents a view according to arrow F6 in FIG. 2;

FIG. 7 represents a cross-section according to line VII-VII in FIG. 6, wherein the uppermost panel-shaped element, however, is represented in a vertical position;

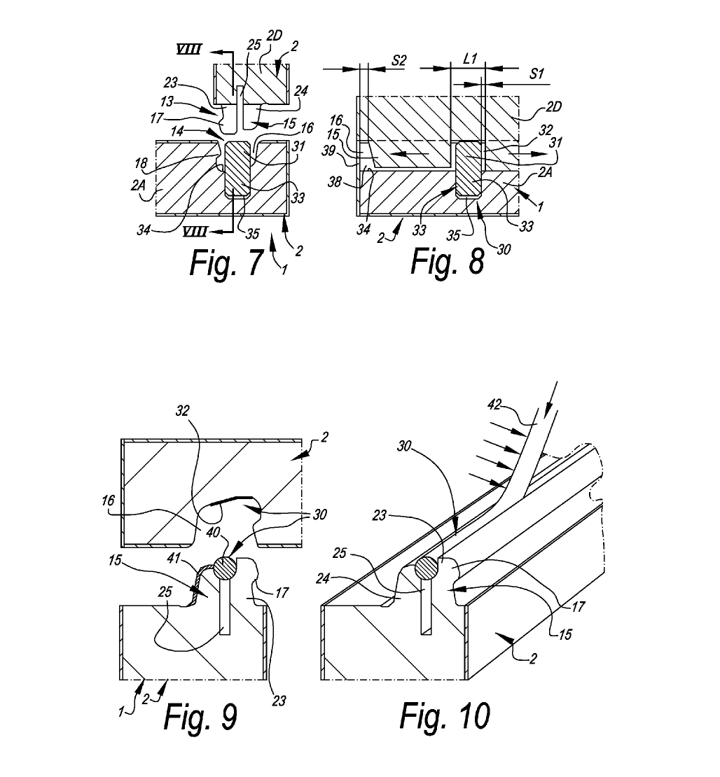

FIG. 8 represents a cross-section according to line VIII-VIII in FIG. 7;

FIG. 9 represents another portion of a composed element according to the invention;

FIG. 10 represents another variant of the invention, which variant applies at least the fifth aspect of the invention;

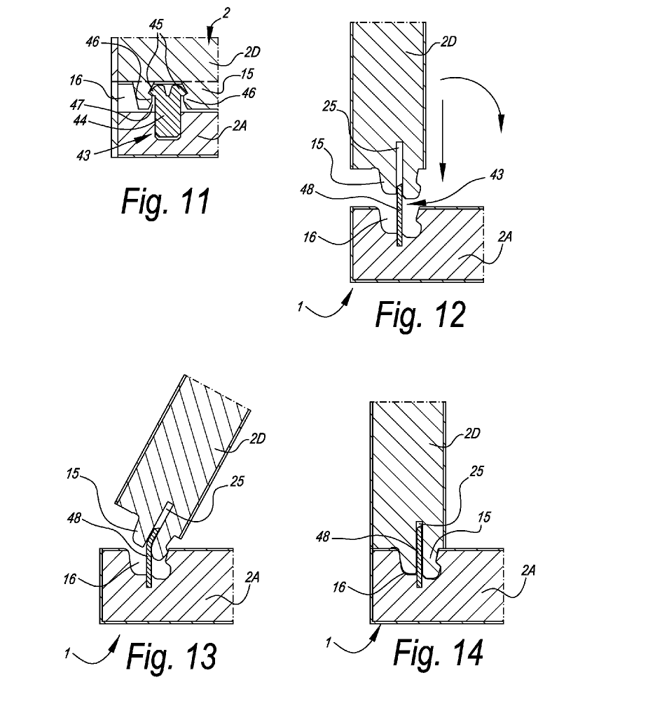

FIG. 11, in cross-section, represents a portion of a composed element according to the invention, wherein the second aspect of the invention is applied;

FIGS. 12 to 14 represent another embodiment of the second aspect of the invention, for various conditions during assembly;

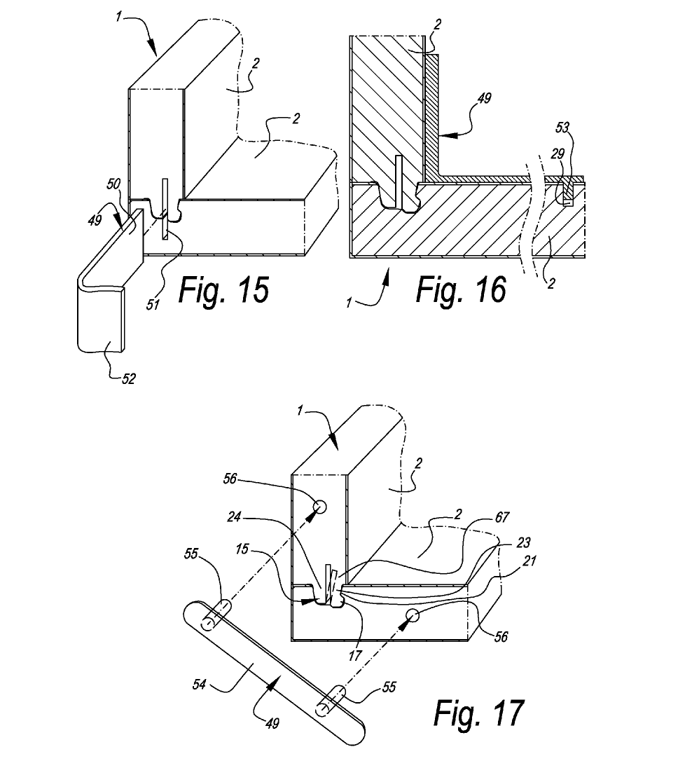

FIGS. 15, 16, 17 and 18 represent another four different embodiments of the second aspect of the invention;

FIGS. 19 to 21 illustrate the third aspect of the invention;

FIG. 22 represents an embodiment of the fourth aspect of the invention, according to a cross-section as indicated by line XXII-XXII in FIG. 21;

FIG. 23 schematically represents an embodiment of the sixth aspect of the invention;

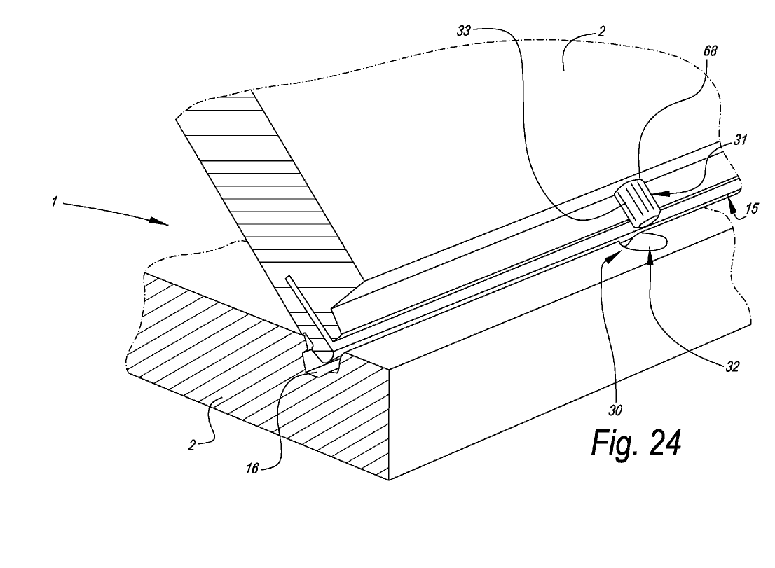

FIG. 24 represents a view similar to that of FIG. 6, for still another embodiment.

In FIG. 1, an example of a composed element 1 according to the invention is represented, in the form of a piece of furniture, more particularly a cabinet, which substantially is composed of panel-shaped elements, which are interconnected at an angle. The panel-shaped elements generally have the reference number 2, however, for distinction, are indicated by 2A, 2B, 2C and 2D, wherein these in the example form the right-hand sidewall 3, bottom wall 4, left-hand sidewall and top wall 6, respectively. Further, this piece of furniture comprises a skirting board 7, a back part 8 and two shelves 9-10.

The different component parts of the composed element 1 are represented in FIG. 2 in dismounted condition, with the exception of the shelves 9-10. Herein, FIG. 2 shows a view wherein the panel-shaped element 2A, thus, the right-hand sidewall 3, has been laid down in order to assembly the piece of furniture starting from this position, as will be described further below.

As becomes clear from the different views from FIGS. 3 to 5 as well as FIG. 6, the respective panel-shaped elements 2 possess coupling zones 11-12, in which coupling parts 13-14 are present in the form of a profiled part respectively extending in the longitudinal direction of the coupling zone concerned, wherein these profiled parts allow respectively coupling the panel-shaped elements 2 to each other in a locking manner and at angle. In the represented example, herein use is made of coupling parts 13-14, more particularly profiled parts, which as such are known already from document DE 20 2009 008 825 U1.

More particularly, the coupling parts 13-14 substantially are realized in the form of a tongue 15 and a groove 16, which are made as profiled parts in the board material itself, from which the panel-shaped elements substantially are made, and also comprise locking parts 17-18, which, in the coupled condition, prevent the moving apart of the tongue 15 and groove 16. These locking parts 17-18 are made as ribs or edges, which form part of the aforementioned profiled parts.

As represented, it is preferred herein that the tongue 15 respectively is situated at a distal end 19 of the respective panel-shaped element 2, whereas the groove 16 is situated in the sidewall 20 of the other panel-shaped element 1, in other words, in one of the large surfaces thereof. In the example, the coupling zone 11 then is formed by the small edge of the respective panel-shaped element at which the tongue is situated. The coupling zone 12 then consists respectively of a zone of the other panel-shaped element, against which the aforementioned small edge of such panel-shaped element is adjoining.

In the represented example, the coupling parts 13-14 moreover show the following characteristics:
The tongue 15 fits into the groove 16 by means of a snap connection, such by pushing the respective panel-shaped element with the tongue 15 in its plane towards the groove 16, or vice versa, as illustrated in FIG. 5; in the represented embodiment, this is achieved in that the locking part 17 can perform a sideward elastic movement, possibly in combination with a slight elastic compression of the two locking parts 17-18, and in that this locking part 17 in this manner can engage behind the locking part 18;
The tongue 15 fits into the groove 16 by means of a turning movement, as illustrated in FIG. 4, wherein the turned-in panel-shaped element, in this case 2B, reaches its final position in the rectangular condition;
The tongue 15 and groove 16 are configured such that they can be brought into each other by a turning movement as well as by a snap movement via a translation, thus, in two manners, such at choice of the assembling person; this becomes clear from FIGS. 4 and 5, which show both coupling techniques for the same shape of tongue and groove;
The locking part 17 at the tongue 15 is situated at the side 21 of the tongue 15 directed towards the inner corner 22;
The tongue 15 is split and more particularly comprises two portions 23-24 which are divided by a slit 25;
The tongue 15 is split and consequently comprises two portions 23-24, and only one of these portions, in this case, the portion 23 which also functions as an elastically bendable part, is provided with a locking part 17;
The tongue 15 is split and consequently comprises two portions 23-24, and only one of these portions is provided with a locking part 17, wherein the portion 23 comprising the locking part 17 extends farther in distal direction than the other portion 24;
The tongue 15 is split and the slit 25 extends deeper than the basic surface where the panel-shaped elements 2 adjoin each other;
The tongue 15 can be snapped into the groove 16 by means of a mutual translation movement, wherein the tongue 15 is split and one of the two portions 23-24 of the split tongue 15, to with portion 23, is provided with a locking part 17, wherein this portion 23 is elastically bendable towards the slit 25, and wherein the slit 25 has a width which is equal or larger than the maximum lateral displacement performed by the locking element 17 in respect to the panel-shaped element to which it belongs, during snapping together;
The tongue 15, whether split or not, globally is situated out of the middle of the panel-shaped element 1 and is situated closer to the side situated against the inner corner 22 than to the opposite side; in a T-coupling, wherein the panel-shaped elements 2 are turned into each other, the corner from which the turning movement takes place, has to be regarded as an “inner corner”;
The depth of the groove 16 is a value situated between ⅓ and ⅔ of the thickness of the panel-shaped element in which the groove 16 is situated.

All characteristics listed herein above are combined in the represented tongue and groove profile. However, it is clear that all these characteristics are facultative, and according to not represented variants, such tongue and groove profile may show merely one or a limited number of the above-mentioned characteristics, such according to any combination. This means, amongst others, that the tongue does not necessarily have to be split. Also, the coupling parts can be made different from each other at a number of different edges, and the tongues and grooves applied in the same piece of furniture do not all have to show the same design.

Still another possible characteristic, which, however, is not very explicitly visible in the figures, consists in that in the condition wherein two of such panel-shaped elements 2 are coupled to each other at an angle, along the periphery of the tongue 15, between the outer wall of the tongue 15 and the wall of the groove 16 one or more spaces are present, with the advantage that possible disturbing particles can be pushed away into them. Such spaces may be situated, amongst others, between the distal extremity of the portion 23 and the opposed thereto wall portion of the groove 16, as well as between the distal extremity of the portion 24 and the opposed thereto wall portion of the groove 16.

The piece of furniture represented in FIG. 1 preferably is assembled in a manner as illustrated in FIG. 2. Herein, the panel-shaped element 2A, which is intended for forming a sidewall, is laid down first. Then, the panel-shaped elements 2B and 2D are attached to the panel-shaped element 2A, such by means of turning movements W1 and W2. Herein, FIG. 4 shows how by means of such turning movement the tongue 15 comes to sit in the groove 16 in a locking manner.

Thereafter, the back part 8 is pushed in grooves 26 provided for this purpose, as schematically illustrated by arrows S in FIG. 2. Thereafter, the panel-shaped element 2C is placed on top of the then upwardly directed edges of the panel-shaped elements 2B and 2D, as well as on top of the then upwardly directed edge of the back part 8. By then exerting a downwardly directed pressing force P on the upper panel-shaped element 2C, as illustrated in FIG. 5, the latter is pressed down over the tongues 15, such by means of a snap effect.

It is clear that herein, the skirting board 7 also is provided in time on the proper place between the panel-shaped elements 2A and 2C. Such skirting board 7 can be held in its place in any manner. In the represented example, this is realized by means of plugs 27, which protrude from the extremities of the skirting board 7 and engage in openings 28 in the panel-shaped elements 2A and 2C. The shelves 9-10 possibly may be supported by classical pins or the like, which are not depicted and which are provided in openings 29 in the sidewalls 3 and 5 of the piece of furniture.

It is clear that when assembling such piece of furniture, there is a risk that one will present panel-shaped elements to each other in a wrong manner and will try to join them together in this manner. Herein then, for example, a condition will occur wherein the tongue 15 comes to sit in a reversed manner in front of the groove 16. By then trying to wring or to pound the respective panel-shaped elements into each other, the coupling parts may break off, become torn or the like.

In order to exclude such risk, or at least reduce it, the composed element, in accordance with the first aspect of the invention, is equipped with auxiliary means 30, which assist in a correct mutual assembly of the panel-shaped elements 2.

As represented in FIGS. 2, 6, 7 and 8, these auxiliary means 30 in the represented embodiment consist of indications in the form of three-dimensional form elements, which in this example are formed by respectively a protrusion 31 and a pertaining recess 32. As is clearly shown in the FIGS. 6 to 8, the respective protrusion 31 is situated in the groove 16 and the recess 32 is provided in the tongue 15, such in the form of a local interruption of the tongue 15, which in the FIGS. 6 to 8 is indicated by a length L1. Herein, the protrusion 31 is formed by a plug 33, which is provided in the bottom 34 of the groove 16 in a hole 35 bored for this purpose and which protrudes from said bottom.

As indicated in FIG. 6, the indication can make combined use of three-dimensional form elements and color marks. The color marks 36-37 are represented in a dotted manner and in reality consist in that by means of a colorant, such as ink, paint of the like, related portions of the coupling parts are provided with a corresponding color. In the represented example, this relates to colorant sprayed over the surface of the form elements, thus, over the protrusion 31 and over the interior side of the recess 32.

It is clear that the situation and the implementation of the indications at the panel-shaped elements 2 can be chosen by the manufacturer in function of the intended effect. For example, one may strive for that, when the indications are followed, none of the panel-shaped elements is mutually exchangeable and none of the panel-shaped elements 2 can be presented to each other in a wrong manner. When certain panel-shaped elements 2 of a composed element are identical and thus are interchangeable indeed, similar indications at identical panel-shaped elements may be used, as then it is of no consequence whether the panel-shaped elements are interchanged or not. Also, it is possible to apply such indications for excluding only a limited number of wrong assembly possibilities, for example, merely for preventing that a panel-shaped element having an asymmetric tongue 15 is inserted with the tongue 15 in reverse direction into the groove 16, whereas the correct assembly of the composed element 1 then also has to be deduced from other characteristics, such as simply the shape of the panel-shaped elements 2, the location where the groove 26 for the back part 8 is placed, and so on.

In the practical example of FIG. 2, preferably protrusions, more particularly plugs, are provided in the grooves at the indicated locations P1, P2, P3 and P4, whereas corresponding recesses, which are intended to work together with them, are provided at the locations P5, P6, P7 and P8 in the tongue profiles. Further, herein the locations P1, P3, P5 and P7 preferably all are marked with the same first color, for example, red, whereas the locations P2, P4, P6 and P8 are marked with another, second color, for example, green.

FIGS. 2 and 6 also illustrate that the indications preferably are provided asymmetrically along the pertaining edge. This means that they are not provided in the middle of the length of the edge, but out of the middle thereof, more particularly eccentrically over a distance E.

FIGS. 6 to 8 also make clear that the auxiliary means 30 represented in this embodiment shall function as obstruction means in the case that certain wrong manners of assembly are applied. Indeed, when a panel-shaped element 2 is presented with a tongue 15 to a groove 16 in such a manner that the respective protrusion 31 is not situated opposite to a recess 32, the tongue 15 will touch the protrusion 32 and the insertion of the tongue 15 in the groove 16 will be made impossible at an early stage.

It is noted that the auxiliary means 30 represented in the example have a double function. On the one hand, these auxiliary means 30 assist in that in a corner connection the correct panel-shaped elements 2 are interconnected, however, on the other hand, they also prevent that the respective two panel-shaped elements 2 belonging together are coupled to each other in such a mutually shifted position that damages might occur. This latter is explained below with reference to FIG. 8. According to FIG. 8, the groove 16 is sealed at its end 38 by means of a finishing strip 39, such as an glued-on edging tape, in order to hide the groove 16, as well as the tongue 15 possibly present therein, from view. This is also clearly visible in the perspective view from FIG. 6. This technique is known as such from document DE 20 2009 008 825 U1. A disadvantage thereof is that, in the case that an as such relatively thin finishing strip 39 is applied, such as a laminate tape, this can be easily broken and/or damaged when turning a tongue 15 into the groove 16, when the panel-shaped elements 2 to be coupled are situated in a mutually shifted position and the tongue 15 becomes situated on top of the finishing strip 39. However, when the free space S1 indicated in FIG. 8 is kept sufficiently small, it is impossible that the tongue 15, which is cut away towards its extremity over a distance S2, touches the finishing strip 39.

In FIG. 9, a variant is represented wherein the color mark, at least at one of the two cooperating coupling zones, in this case at the tongue 15, is performed in the form of a separate material part, in this case a synthetic material strip 40, of a differing color.

By a “separate material part”, any element is to be understood which has a substantial volume, in other words, any element which is different from a merely spread thin coloring layer, thus, other than merely ink or paint. By a “differing color”, a color is to be understood which is different from the color of the remainder of the surface, and preferably a distinct color which clearly differs form the basic material of the panel-shaped element 2, which latter preferably is particle board or MDF or HDF.

According to FIG. 9, the synthetic material strip 40 is provided in the slit 25 of the tongue 15 or even in a widened part formed especially for this purpose.

10

This synthetic material strip 40 can be merely intended for forming a color mark, such as aforementioned, but may also be an element having already another function. In the practical embodiment of FIG. 9, the synthetic material strip 40 offers a reinforcement in the form of an elastic filler in the slit 25 of a split tongue 15. Herein, the filler consists, for example, of colored foamed glue, such as a foamed “hot melt” glue, which is sprayed into the slit 25 and forms an elastic connection between the two portions 23-24 of the split tongue 15. Herein, the filler forms a reinforcement in two respects. On the one hand, an elastic support of the locking part 17 is obtained, or at least of the bendable portion 23 at which the locking part 17 is situated. On the other hand, the connection also provides for that, with the possible occurrence of a tear in the portion 23 comprising the locking part 17, there still remains a connection by means of the filler.

It is clear that the separate material part, in this case, thus, the synthetic material strip 40, in this manner forms a functional part of the coupling parts.

In FIG. 9, in the same figure another variant is represented, wherein a colored strip has been provided on the surface of the tongue 15, for example, in the form of synthetic material or glue, which is provided on the surface and still better is taken up at least partially and/or entirely in the surface and in this manner forms a layer which reinforces the surface. It is clear that a combination of both, thus the synthetic material strip 40 and the strip 42, is possible.

The corresponding mark in the groove 16 can simply consist of a color mark 32, which in that case thus can also extend over the entire length of the groove.

In FIG. 10, a variant is represented, wherein the aforementioned material part, which is provided in the split tongue 15, functions as a support element and wherein this support element consists of a cord-shaped element 42, which is provided in the slit 25 in the form of an element implemented as a cord already beforehand. The application thereof is also represented schematically in FIG. 10 and consists in that the cord systematically is pressed down in the slit 25, possibly in a special seat or widened part therefor. This embodiment is an example of the fifth aspect of the invention. If the material part is also applied as a color mark, it also forms an example of the first aspect of the invention. The cord-shaped element 42 may also be performed as a synthetic material strip.

In FIG. 11, a portion of a composed element 1 is represented, to with in a view similar to that of FIG. 8, wherein the second aspect of the invention is applied, more particularly wherein use is made of auxiliary means 43, which assist in holding an upwardly turned panel-shaped element 2, for example, 2D, upright during assembly. In the represented embodiment, the auxiliary means 43 comprise an auxiliary element or auxiliary piece 44, in this case, a plug, too, which is fixedly mounted in the bottom of the groove 16, with one or more locking parts 45, which laterally cooperate with one or more locking parts 46 in a recess 47 in the tongue 15. In this manner, it is obtained that, when the panel-shaped element 2D is turned upward in a groove 16, an engagement is achieved offering at least a slight engagement force, by which the upwardly turned panel-shaped element 2D will not tilt down by itself.

FIGS. 12 to 14 represent a variant of the second aspect of the invention. The auxiliary means 43 comprise an auxiliary element 48, which consists of a relatively stiff, however, still elastically bendable pin or lip, which is attached in the bottom of the groove 16 or can be attached in the bottom by the user, for example, can be inserted in a groove provided for that purpose. This allows that the upright-directed panel-shaped element 2D, as represented in FIG. 12, first can be shifted with the split tongue 15 over the auxiliary element 48. Thereafter, the panel-shaped elements, as illustrated in FIG. 13, can be turned into each other, wherein the tongue 15 is forced with its slit 25 further over the auxiliary element 48. Finally, a situation is obtained as in FIG. 14, wherein the upright panel-shaped element 2D in fact still can be turned down, however, the auxiliary element 48 exerts an upright-holding force which suffices to prevent that the upwardly directed panel-shaped element 2D would tilt down by itself or when slightly pushed.

FIGS. 15 to 18 represent another four variants of the second aspect of the invention, wherein instead of a separate auxiliary element, which is present at the panel-shaped elements themselves, now for the auxiliary means 43 an auxiliary element 49 is used in the form of a separate tool belonging to the composed element 1, which tool is temporarily applied when waiting until other component parts are provided on their location, which then exclude the tilting down of the panels-shaped elements concerned.

According to FIG. 15, an auxiliary element 49 in the form of a relatively rigid lamella 50 is applied, which, as indicated, can be slid sideward in the slit 25 of the tongue 15, as well as partially in a slit 51 in the bottom of the groove 16, for example, along the back side of the piece of furniture. In this manner, a situation analogous to that of FIG. 14 is created, however, with a rigid auxiliary element, which prevents the turning down of the upright panel-shaped element 2. A possibly provided bent portion 52 or the like prevents that the lamella is pressed completely into the piece of furniture and at the same time forms a handhold for removing the auxiliary element again.

According to FIG. 16, use is made of an auxiliary element 49 in the form of an angle piece, which temporarily is placed against the inner corner concerned and in this manner offers a temporary support against the tilting down of the upright panel-shaped element 2. In order to prevent that this auxiliary element 49 is displaced, means are provided whereby it can be held in a simple manner on at least one of the panel-shaped elements, in this case the laid down element 2. In the example, to this aim one leg of the angle piece is provided with a pen 53, which engages in an opening, for example, in one of the bore openings 29, which may be present in the panel-shaped element concerned, which are intended for providing support pens or pins for shelves therein later on.

FIG. 17 represents a variant, wherein the auxiliary element 49 is made as a connecting piece, by which, so to speak, a diagonal support can be realized between the two panel-shaped elements 2. The connecting piece consists of a rigid body 54 with two pens 55 fitting into holes 56 formed especially for this purpose in the small faces of the panel-shaped elements. These holes 56 can be provided in the back side of the piece of furniture, such that they are inconspicuous.

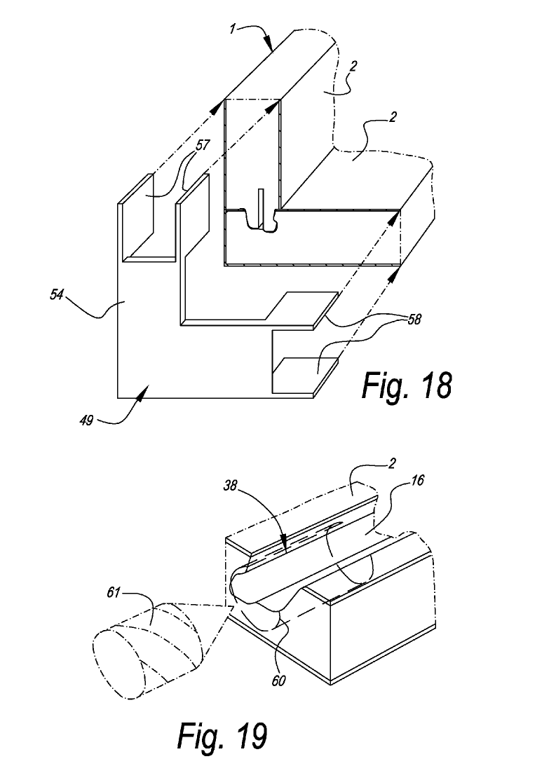

FIG. 18 represents a variant, wherein instead of pens 55, use is made of beaks 57-58, by which the auxiliary element 49 can be pushed over the edges of the panel-shaped elements 2, which latter temporarily have to be fixedly held in mutual respect. The advantage therein is that it is no longer necessary to provide separate holes 56 in the panel-shaped elements 2.

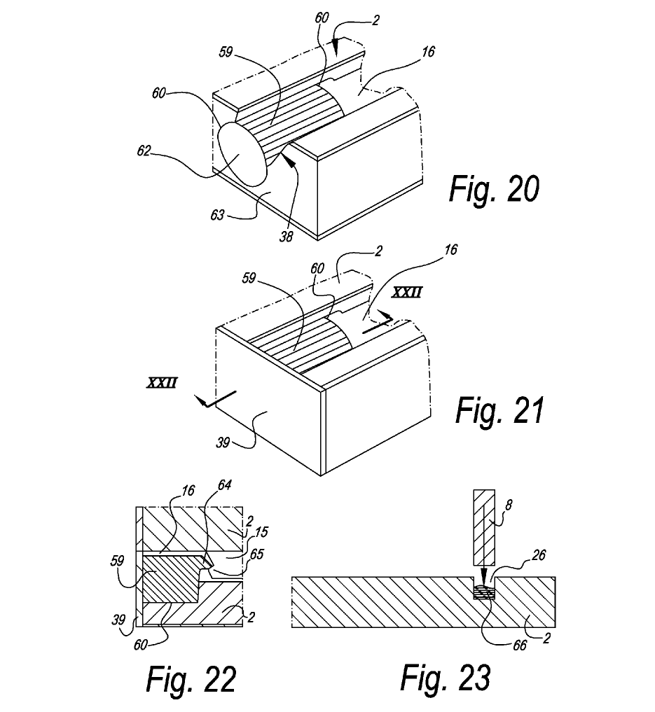

FIGS. 19 to 21 illustrate the third aspect of the invention, wherein, for simplicity's sake, exclusively a portion of a panel-shaped element 2 is represented, which comprises a profiled part in the form of a groove 16. The particularity herein consists in that the extremity 38 of the groove 15 is sealed by means of a sealing element 59, which is made in the form of a plug provided in a bore hole 60. FIG. 19 schematically represents how a bore hole 60 can be formed by means of a bore 61. Herein, the bore direction is parallel to the longitudinal direction of the groove 16. Thus, the bore hole 60 substantially provides for a cylindrical hollow part around the previously present groove 16. FIG. 20 represents how a sealing element in the form of a cylindrical plug is provided in the bore hole 60. Preferably, the plug is glued into the hole, however, it may also be clamped in place therein. The outwardly directed extremity 62 of the plug preferably is flat and coincides with the respective small edge or face 63 of the panel-shaped element 2. This can be achieved, for example, by inserting the plug into the bore hole 60 up to such a depth that the end 62 is flush with the small face 63 of the panel-shaped element 2. According to another possibility, the plug is protruding a little bit and subsequently is milled flush with the small face 63 of the panel-shaped element 2. FIG. 21 shows the final situation after providing the finishing tape 39, which then is fixedly glued to the small face 63 as well as to the end 62 of the plug. Although the plug is round and consequently the groove 16 usually will not be completely filled by it, as a result of which the finishing strip 39 is not completely supported, still a useful final situation is obtained, and such in a constructively simple manner. By the presence of the plug, the finishing strip 39 namely is protected to a large extent against incorrect insertion of the tongue 15 and/or against other forms of damage. Also, the finishing strip 39 can be fixedly glued over the major part of the area where otherwise the groove 16 would be situated.

It is noted that the plug, according to a variant, can also be provided exclusively as a protection against the tongue 15 and not for supporting the finishing strip 39. In such case, the plug does not necessarily have to adjoin the finishing strip.

FIG. 22 represents an example of the fourth aspect of the invention. Herein, FIG. 22 represents a cross-section of two coupled panel-shaped elements 2, wherein this cross-section extends according to a plane as indicated by XXII-XXII in FIG. 21, however, in respect to the embodiment, in fact is a variant of FIG. 21. Herein, the tongue 15 can be a tongue of any shape, however, preferably is a tongue 15 of the type as represented in the preceding figures, more particularly a split tongue 15 having a locking part 17, as aforementioned. The particularity of the fourth aspect consists in that the sealing element 59 comprises a locking portion 64, which, in the coupled condition of the panel-shaped elements 2, can cooperate with the panel-shaped element 2 comprising the tongue 15. In the represented example, this locking portion 64 is formed by a protruding edge, which, by means of a snap effect, for example, by means of the elasticity of the material from which the sealing element is made, can cooperate with a locking portion 65 situated at the small longitudinal end of the tongue 15.

It is also noted that for such sealing element 59, irrespective whether this is made as a plug or another element, a distinctly colored element can be applied in order also to provide for a color mark in this manner, which, together with a corresponding color mark in the groove 16, can be applied for realizing the first aspect of the invention.

FIG. 23 represents an example of the sixth aspect of the invention. In the figure, a panel-shaped element 2 is represented schematically, which is provided with a groove 29 for a back part 8. In the groove 29, an industrially dimensioned tensioning and/or filling means 66 is present. Herein, this relates to an elastically compressible matter, for example, an elastic synthetic material, which, in the assembled condition, provides for that the back is taken up in a somewhat tensioned condition, by which a piece of furniture can be given additional stability.

In FIG. 17, as an alternative still another particular independent aspect of the invention is represented in dashed line, which in general can be applied in a corner connection with a split tongue 15. According to this aspect, in the tongue 15 an obliquely directed slit 67 is applied, which in the represented direction deviates from the main direction of the panel-shaped element. The advantage thereof is that the portion 23 having the locking part 17 becomes more flexible and/or that the slit 67 must be made less deep for obtaining the same flexibility as with a slit made parallel to the plane of the composed element.

In FIG. 24 another variant of the embodiment of FIG. 6 is represented. Hereby, it is made clear that such protrusion 31 and recess 32 can also be provided on other locations. More particularly, FIG. 24 makes clear that such protrusion 31 can also be situated at the panel-shaped element 2 which comprises the tongue 15, more particularly on the small edge of this panel-shaped element, whereas the recess 32 then is situated at the panel-shaped element 2, which comprises the groove 16. FIG. 24 also makes clear that such protrusion 31 and the recess 32 can be situated at least partially and preferably entirely or almost entirely next to the actual tongue 15 and groove 16. As FIG. 24 illustrates, it is preferred that in such case, too, for the protrusion use is made of a plug 33 mounted in an opening 68, whereas the recess 32 is formed by a corresponding bore hole. By a corresponding bore hole, it is meant that it is provided on a location which, in the assembled condition of the whole, corresponds to the location of the plug; however, this does not mean that the bore hole necessarily has to have precisely the same dimensions as the plug. Preferably even, the bore hole has a somewhat larger diameter than that of the protruding portion of the plug.

In the case that the tongue 15 and groove 16 can be engaged into each other by means of a turning movement, it is preferred that the protrusion 31, as represented in FIG. 24, is situated at that side of the tongue 15 which is directed away from the corner from which the panel-shaped element to be turned is turned with the tongue into the groove. The person assembling the piece of furniture then has a good view on the protrusion 31 and the recess 32, such that he can see from the start whether he is coupling the correct panel-shaped elements to each other.

As can also be deduced from FIG. 24, the tongue 15 preferably is situated eccentrically displaced on the small face of the panel-shaped element, such in one direction, whereas such protrusion then is situated on the small face eccentrically displaced in the other direction.

It is clear that the use of protrusions 31 and recesses 32, in a manner as explained herein above by means of FIG. 24, can also be combined with color marks, inscriptions or the like.

It is noted that in the same composed element, and possibly even at the same corner connection, use can be made of different types or forms of three-dimensional form elements. For example, in a same composed element a plug may be used which is provided at the tongue side, whereas at another location, a plug is used which is situated in or next to a groove.

It is also noted that, where applicable, the invention is not limited to corner connections extending in horizontal directions in the assembled usage condition, but can also be applied for corner connections extending in other directions, for example, the vertical direction. An example of a vertically extending connection, by which is meant that the coupling zones extend in vertical direction, is obtained, for example, when two sidewalls of a cabinet are connected to a back part by means of a corner connection, for example, of the type as represented in FIGS. 4 and 5, for example, as illustrated in FIGS. 54-55 of the aforementioned document DE 20 2009 008 825 U1.

It is also noted that according to the invention, by a “composed element” an element has to be understood in “composed” as well as in “still to be composed” condition. This then also means, for example, that a not yet assembled and still packaged flat-pack piece of furniture, which in assembled condition shows one or more of the characteristics of the invention, also has to be considered a “composed element” already.

It is also noted that the aforementioned sealing element and all aforementioned plugs or other protrusions can consist of any material, such as wood, synthetic material and so on. When they have to provide for a locking effect, preferably, for stability and elasticity, use is made of synthetic material. Synthetic material also offers the advantage that it is easy to work with colors as markings, simply by choosing synthetic material of another color.

As also becomes clear from the above description, it is emphasized that, when the aforementioned indications comprise three-dimensional form elements, this does not necessarily have to be combined with color marks, inscriptions or the like, although such combination indeed is preferred.

The present invention is in no way limited to the embodiments described by way of example and represented in the figures, however, such composed elements and more particularly the portions thereof which provide for realizing the aforementioned aspects, can be realized according to different variants without leaving the scope of the invention.

1-27. (canceled)

28. Composed element comprising two or more panel-shaped elements, which each possess a coupling zone in which coupling parts are present in the form of a profiled part respectively extending in the longitudinal direction of the coupling zone concerned, wherein these profiled parts allow coupling the panel-shaped elements to each other in a locking manner and at angle, wherein the composed element comprises auxiliary means, which assist in a correct mutual assembly of the panel-shaped elements.

29. The composed element of claim 28, wherein the auxiliary means are configured at least such that they prevent that incorrect panel-shaped elements are coupled to each other and/or panel-shaped elements are coupled to each other with the incorrect coupling zones.

30. The composed element of claim 28, wherein the auxiliary means) are configured at least such that they prevent that the panel-shaped elements are coupled to each other in a mutually shifted position.

31. The composed element of claim 28, wherein the aforementioned auxiliary means consist of indications, which are provided at least on a number of the panel-shaped elements.

32. The composed element of claim 31, wherein the aforementioned indications consist of corresponding indications, which respectively are provided on the respective two panel-shaped elements to be connected.

33. The composed element of claim 31, wherein the indications are formed at least of marks provided on the surface.

34. The composed element of claim 33, wherein the aforementioned marks consist of color marks, wherein matching parts are marked with the same color.

35. The composed element of claim 34, wherein the color marks, at least at one of the two cooperating coupling zones, are realized in the form of a separate material part with a differing color.

36. The composed element of claim 31, wherein the aforementioned indications comprise three-dimensional form elements.

37. The composed element of claim 28, wherein the aforementioned auxiliary means are realized as three-dimensional form elements, which function as obstruction elements mechanically preventing a certain incorrect mutual assembly of the panel-shaped elements.

38. The composed element of claim 37, wherein the three-dimensional form elements consist of one or more protrusions and recesses, which, with a correct assembly, fit into each other.

39. The composed element of claim 38, wherein one or more of the aforementioned protrusions consist of a plug, which then respectively can cooperate with a recess.

40. The composed element of claim 38, wherein the aforementioned coupling parts comprise a tongue and a groove and wherein at least one of the protrusions and the corresponding recess are realized according to any of the following possibilities:
the protrusion is situated in the groove, preferably in the form of a plug protruding from the bottom of the groove, whereas the recess is provided in the tongue, preferably in the form of a local interruption in the tongue profile;
the protrusion is situated entirely or almost entirely next to the tongue, preferably in the form of a protruding plug, whereas the recess is situated at the panel-shaped element having the groove, and preferably is realized in the form of a bore hole.

41. The composed element of claim 28, wherein the auxiliary means are provided such that, in the coupled condition of the panel-shaped elements, they are hidden from view.

42. The composed element of claim 28, wherein the auxiliary means are applied at coupling zones with coupling parts which are realized in the form of a tongue and a groove, wherein these coupling parts also comprise locking parts, and wherein the tongue is made asymmetrically and preferably comprises a locking element on only one side and in particular preferably is split, too.

43. The composed element of claim 28, wherein the panel-shaped elements substantially consist of particle board, MDF board or HDF board, wherein the aforementioned profiled parts are realized from this material.

44. The composed element of claim 38, wherein the aforementioned auxiliary means are of such a type that they are situated within the large flat sides of the panel-shaped elements, such that the panel-shaped elements at their large flat sides are free from protrusions extending beyond these flat sides.

45. Composed element comprising at least two panel-shaped elements, which possess a coupling zone in which coupling parts are present in the form of a respective profiled part, wherein these profiled parts allow to couple the panel-shaped elements to each other in a locking manner and at an angle, by putting down one of the panel-shaped elements and coupling the other panel-shaped element to the put-down panel-shaped element by means of an upward turning movement, wherein the composed element comprises auxiliary means, which assist the upward-turned panel-shaped element in remaining upright during the further assembly of the composed element.

46. The composed element of claim 45, wherein the auxiliary means comprise an auxiliary element provided in at least one of the panel-shaped elements to be connected.

47. The composed element of claim 45, wherein the auxiliary means comprise an auxiliary element in the form of a separate tool, more particularly a tool developed especially for this purpose.

48. Composed element comprising at least two panel-shaped elements, which each possess a coupling zone in which coupling parts are present in the form of a respective profiled part, wherein these profiled parts allow to couple the panel-shaped elements to each other in a locking manner and at an angle; wherein these profiled parts are made in the form of a tongue and a groove; wherein the tongue is made as a split tongue, which, by means of a slit, is divided into at least two parts; wherein this split tongue comprises a locking part at least at one side, which locking part can cooperate with a locking part in the groove; wherein in said slit, a support element is provided, which extends between the directed towards each other sidewalls of the slit; wherein the support element consists of a cord-like element, which is provided in the slit in the form of an element which has already been given the form of a cord beforehand.
